(19) United States
(12) Patent Application Publication
(10) Pub. No.: US 2010/0215466 A1
(43) Pub. Date: Aug. 26, 2010

(54) Loading and Unloading Arrangement for a Vehicle

(76) Inventor: William Chester Cline, Moe (AU)

Correspondence Address: JACOBSON HOLMAN PLLC, 400 SEVENTH STREET N.W., SUITE 600, WASHINGTON, DC, 20004, US

(21) Appl. No.: 12/086,477

(22) PCT Filed: Feb. 1, 2008
(86) PCT No.: PCT/AU2008/000111

§ 371 Date: Jun. 13, 2008

(30) Foreign Application Priority Data
Feb. 2, 2007 (AU) 2007900483

(51) Int. Cl. B60P 1/00; B60P 1/02; B60P 1/52

(52) U.S. Cl. 414/495

(57) ABSTRACT

An arrangement for a vehicle, for loading and unloading a transport load on or from the vehicle, vehicle includes a support member having a surface onto which the transport load can be located and a ground engaging wheel assembly. At least one wheel of the wheel assembly is positioned proximate to the support member and the arrangement has at least one height adjustment device for operatively engaging the transport load with the at least one wheel. As the vehicle is moved with the transport load engaged with the wheel, the transport load is able to move across and/or along the support member, in the direction in which the vehicle is moved, by rotation of the wheel.

### FIELD OF THE INVENTION

The present invention generally relates to a loading and unloading arrangement for a vehicle. The invention is particularly applicable to a loading and unloading arrangement for trucks and trailers having a tilt, slide, drop and retrieve action and it can be convenient to hereinafter disclose the invention in relation to that exemplary application. However, it is to be appreciated that the invention is not limited to that application and could be used in any vehicle having a support member onto which a transport load could be loaded and unloaded.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

A large variety of loading and unloading arrangements are available for loading and unloading transport loads, such as crates or containers, from a transport vehicle such as a truck or a trailer. In some instances an external means, for example man-power, or an external apparatus, such as a forklift, crane, or conveyor, can be used to load and unload transport loads from a vehicle. In other instances, the vehicle can include specialised lifting arrangement to load and unload transport loads from a support member of the vehicle. Scrap metal and construction waste is normally transported in special open top containers which use specialized lifting equipment, for example an articulated arm with a hook, to lift the containers to and from the support member. Gravel, dirt, fertilizer and other similar products are transported in specialized dump trucks and trailers which include a lifting device to raise one end of the support member to tip the contents thereon off the end of the support member.

Each of these conventional loading and unloading arrangements has specific limitations. Thus, loading and unloading arrangements adapted to tilt a support member to slide the transport load(s) off the support member of a vehicle are unable to easily unload a tray located on the support member to ground level and leave this tray behind. Additionally, this arrangement cannot vertically drop a transport load from a support member. In this respect, such tilting loading arrangements use hydraulic rams to tilt the support member and one or more guides arranged between the support member and the tray to guide sliding motion of the tray relative to the support member.

In some arrangements, the sliding movement is controlled using at least one cable connected between the support member and a winch. As can be appreciated, such cable roll off type arrangements must tilt the support member to a high angle to operate effectively. The load is typically raised to a high angle using hydraulic rams. The load is then allowed to roll or slide down guide rails or tracks set in the support member under the control of the winch. This high angle can limit the types of load that can be used on this type of arrangement. Additionally, the arrangement should be operated with caution in order to limit rollover of the load.

Loading and unloading arrangements which include hook lift units have a large moveable hook assembly which pivots via hydraulic rams to lift a transport load to and from a support member on a vehicle. These lift units can take up a large amount of operational space on the support member of a vehicle, and can be heavy and expensive.

Accordingly, each existing loading and unloading arrangement is complicated, and expensive, having significant purchase, operating and maintenance cost. It would therefore be desirable to provide an alternative loading and unloading arrangement for a vehicle truck or trailer that addresses one or more disadvantages of existing loading and unloading arrangements.

### SUMMARY OF THE INVENTION

According to the present invention, there is provided a loading and unloading arrangement for loading and unloading at least one transport load on or from a vehicle. The vehicle includes at least one support member onto which a transport load can be located and a ground engaging wheel assembly. The loading and unloading arrangement includes at least one wheel of the wheel assembly positioned proximate to the at least one support member; and a height adjustment device for adjusting the transport load into and out of engagement with the at least one wheel. In use, the arrangement is operable, as the vehicle is moved with the transport load engaged with the wheel, to move the transport load across and/or along the support member, in the direction in which the vehicle is moved, by rotation of the wheel.

An arrangement according to the present invention therefore utilizes at least one wheel of the vehicle to support the transport load during operation and to provide directional force to move the transport load across and/or along the support member. As can be appreciated, the support member and transport load thereon are located in a position in which the transport load is clear of the at least one wheel during normal transport operation of the vehicle. When unloading is required, the transport load is operatively engaged with the at least one wheel. The wheel can then be rotated to move the transport load in the required direction relative to the support member.

In one preferred embodiment, the vehicle is a truck or trailer. In such an embodiment, the transport load can be moved rearwardly of a support member of the truck or trailer by reversing the vehicle. As can be appreciated, the center of gravity of the object will eventually pass over the rotational axis of the wheel and tip downwardly towards the ground during this unloading procedure.

It should be appreciated that the support member is that part or member of the vehicle having a support surface onto which the transport load is seated for transportation. The support member can include an elongate support surface, such as a surface of a plate or of at least one beam of the vehicle body. Equally, the support member could include one or more smaller support surfaces such as for example a plate or upper surface or a fixture attached to a piston or the like.

The loading and unloading arrangement preferably further includes a control device for limiting and controlling the movement of the transport load relative to the at least one support member. The control device can be a winch, cable, chain, or webbing device, or hydraulic, pneumatic, electric, mechanical, or manual winding device.

In one preferred embodiment, the control device is a winch which is releasably attachable to the transport load. Preferably, the winch includes at least one elongate flexible cable operatively connected between the winch and the transport load. More preferably, the control device can include one or more of a manual, hydraulic, pneumatic, mechanic, or electric powered winch, using chain or cable as the restraining and winching means.

It should be appreciated that operation of the control device may be entirely manual, automatic, or a combination thereof. The control device could be controlled remotely, controlled directly, or controlled from the driver's seat. Hydraulic, pneumatic, electrical, or mechanical means could help add extra control to the transport load movement. Furthermore, any controls for operating the control device could be permanently mounted within the vehicle driver's reach, and/or remotely controlled.

The control device is preferably configured to limit and control movement of the transport load until the transport load reaches the required final unloaded or loaded position. When the transport load is a tray or container, the required final position can be with the rear of the tray or container resting on the ground, with the leading edge of the tray or container still resting on the a rear surface or edge of the support member. In other applications, the final position may be when the transport load is lowered completely to ground level, where the transport load can be left behind, or loaded or unloaded safely at ground level as required.

It is preferable to use the control device to move the transport load onto the at least one support member when loading the transport load from an external location onto the vehicle. The direction of actuation of the control device can be reversed to lift and pull the transport load onto the support member. In some embodiments, the control device can be used to move the transport load back into operative engagement with the at least one wheel. Rotation of the at least one wheel rotation can return the transport load to a position suitable for transporting the transport load on the support member. That is, as the vehicle is driven in the relevant direction with the transport load pulled onto the vehicle to bring the transport load into engagement with the at least one wheel, the arrangement is operable to move the transport load across and/or along the support surface in that direction.

In some embodiments, the control device is able to be used to load the transport load onto the support member without using the at least one wheel to move the transport load. In this respect, the control device moves the transport load relative to the support member to a position for transporting the transport load on the support member. In these embodiments, the at least one height adjustment device is preferably placed in disengaged state in which the transport load can move freely of the at least one wheel when loading the transport load onto the at least one support member from an external location.

The height adjustment device can be any member or arrangement capable of operatively engaging the transport load with the at least one wheel.

In one embodiment, the at least one height adjustment device is configured to move the at least one support member between a first position in which a transport load located on the at least one support member is spaced from the at least one wheel and a second position in which the transport load is operatively engaged with the at least one wheel by resting on the wheel. In one embodiment, this can be achieved by using a piston or other height actuator to lower the transport load from the first position to the second position. The transport load may be raised and lowered directly or indirectly, such as hydraulically, pneumatically, electrically, mechanically, manually or a combination thereof. This movement can also be accomplished via linkage or guide mechanisms during normal operation of the control device.

With a vehicle which includes a suspension system by which a body of the vehicle is mounted on the at least one wheel, the height adjustment device can be operable through the suspension system to raise and lower the support member between the first and second positions. The vehicle suspension system can be raised and lowered hydraulically, pneumatically, electrically, mechanically, manually or a combination thereof.

In an alternate embodiment, the height adjustment device includes at least one wedge member or device that can be inserted between a base section of the transport load and the at least one wheel to operatively engage the at least one transport load with the at least one wheel. The wedge device is able to act as an intermediary body bridging the gap between the base section of the transport load and the at least one wheel and thereby enable rotation of the at least one wheel to impart horizontal movement to the transport load. However, in this case, the wedge device causes the transport load to engage the wheel by lifting the transport load with respect to the wheel as the wedge device is inserted between the transport load and the wheel. The transport load thus is engaged with the wheel through the wedge device, and the wedge device is caused to move with the transport load as the wheel is rotated. Successive parts of the wedge device maintain that engagement. The at least one wedge member can be mounted to the container or vehicle, preferably proximate or to the support surface. In some forms, the wedge member releasably mounts to the container or vehicle.

Of course, the at least one support member can include additional devices or features to aid movement of the transport load relative to the support member.

In one embodiment, a pivot device is provided at an edge of the at least one support member edge over which the transport load is moved to load and unload the transport load. The pivot device is to facilitate movement of the transport load over the at least one support member. Preferably, the pivot device includes at least one roller. The at least one roller can extend the full width of the support member, be narrower than the full width of the support member, or only the width of chassis rails of the vehicle. The or each roller can be made of any suitable material, and may be made from or covered with a resilient material such as rubber.

The pivot device may include a groove configured to seat an attachment cord operatively connected to a winch. Preferably, a sheave or guide is provided in line with the at least one roller to accommodate a flexible connector associated with the control device. Such a flexible connector includes one or more of a chain, webbing, rope, cable, or other.

The at least one support member may have a low friction surface to aid in movement of the transport load across and/or along the support member. The low friction surface preferably is provided by a replaceable wear strip or a guide rail. This replaceable wear strip or guide rail may be made of a low friction material such as Teflon, or be coated with a friction modifier. Alternatively, the support surface may be formed by rollers on which the transport load is moveable across and/or along the support surface.

The at least one support member may include at least one longitudinally track configured to cooperate with an corresponding feature located on the base of transport load to guide longitudinal movement of the transport load across and/or along the support member. Alternatively, the base of transport load may include at least one longitudinally aligned track configured to cooperated with a corresponding elongate feature located on the support surface to guide longitudinal movement of the transport load relative to the at least one support surface. In each case, the longitudinal track may comprise at least one elongate groove which is configured to receive a corresponding feature comprising an elongate rail.

The transport load may include additional features or devices to aid movement of the transport load across and/or along the support member. The rear of the transport load can include a reinforced supporting structure, rollers or the like.

Alternatively, the base of the transport load may include a planar surface along which the at least one wheel can operatively engage to move the transport load across and/or along the at least one support member.

Any number of wheels from the wheel assembly of the vehicle can be operatively engaged with the transport load to actuate movement of the transport load across and/or along the support member. Preferably, the wheel assembly of the vehicle includes at least two spaced apart wheels on a common axis and proximate to the at least one support member which, in use, are able to engage opposite sides of the base of the transport load. Preferably, the at least one wheel is located between the unloading edge and the longitudinal midpoint of the at least one support member.

The transport load can comprise any suitable object that can be loaded or unloaded from a support member of a vehicle. In one embodiment, the transport load comprises a container, such as a shipping container, skip or the like, into which further items, articles, products or produce can be located. In another embodiment, the transport load comprises an elongate tray onto which further items, articles, products or produce can be carried. The tray and/or container can be loaded and unloaded from the support member in the manner described above. In yet other embodiments, the transport load comprises a support framework, such as a support framework for a boat on a boat trailer, or support framework for a horse box or other animal transport structure.

The vehicle could comprise any wheeled vehicle or body capable of supporting a transport load, body or load. Preferably, the vehicle is a truck or a trailer. Examples of suitable vehicles include a trailer for transporting cattle, a low loader transporting plant and equipment, a specialized tractor, or a conventional truck. However, it should be appreciated that the invention is not to be limited to these examples.

In some embodiments, the loading and unloading apparatus could include a tipping mechanism that enables the transport load to be tipped and dumped from the support member. In this respect, the tipping mechanism is preferably capable of generally vertically lifting/raising at least one side of the at least one support member relating to the vehicle in order to angle the at least one support member relative to the vehicle. The tipping mechanism can be mounted on the transport load or the vehicle.

As can be appreciated, a vehicle can be manufactured with a loading and unloading arrangement according to the present invention. Alternatively, the vehicle could be retrofitted or modified to include a loading and unloading arrangement according to the present invention.

In some embodiments, a securement device such as spigots, brackets, bolts, clips, clamps, clasps or the like, can be provided on or proximate to the support member to firmly attached to the transport load to the support member during transportation. Such fasteners can include mechanical, electrical, pneumatic, or hydraulic locking mechanisms.

In one preferred embodiment of the present invention, the vehicle comprises a conventional truck and the transport load comprises a loading tray. In such an embodiment, loading tray is modified to operate in accordance with the present invention. Preferably, the truck is fitted with a pneumatic air suspension system which uses pneumatically inflatable reinforced flexible rubber ‘bags’ to support the truck loads. Air valves are typically provided to level and maintain a correct suspension height and allow the truck or trailer to be raised or lowered relative to the ground to assist loading and unloading. Preferably, the loading tray can be configured to settle or be lowered down onto an upper surface of at least one wheel proximate to the loading tray when air pressure in the suspension system is reduced.

It is preferable for the loading tray of the truck to be modified to include a running board/frame member permanently attached, or integrated into the bottom of the loading tray in order to provide an elongate engagement member of a suitable width and length to engage at least one wheel of the truck and thereby enable the loading tray to be moved relative to the truck chassis. Similarly, it is preferable for the truck chassis to be modified to include low traction sliding pads or rails on which the loading tray be seated when moving relative to the chassis. Longitudinally aligned side guides member are also preferably fitted to the truck chassis to laterally guide the loading tray during longitudinal movement relative to the support member.

The loading and unloading arrangement of the truck preferably includes a winch control device to control longitudinal movement of the loading tray relative to the support member through a flexible cable connected between a winch motor of the winch and the loading tray.

In operation, the truck can be reversed to cause the wheels to rotate and thereby move the loading tray rearwardly. Rearward movement of the tray relative to the support member is controlled by the winch. As the loading tray moves rearwardly, the center of gravity of the tray can pass the axis of rotation of the at least one wheel. The loading tray can then tilt downward toward the ground. The control device can be used to control the speed of movement and the angle of tilt of the loading tray relative to the support member during this operation. One or more rollers fitted to the rearward edge of the support member can contact a portion of the loading tray during this action. Continued rearward movement can tilt the loading tray about the rollers. As the loading tray tilts, contact with the at least one wheel can be lost. Downward and rearward travel of the loading tray can continue, controlled by the winch control device, until the tray contacts the ground. When the rear of the loading tray rests on the ground, reversing of the truck is stopped, and gravity forces due to the weight of the tray against the rear of the truck can cause forward movement of the truck. The winch can be used to move the front edge of the loading tray around and off the one or more rollers, and lower the loading tray to the ground. Once lowered to the ground, the cable of the winch can be disconnected, and the loading tray can be left behind.

To load the loading tray on to the support member of the truck, the truck is reversed up to and in reasonable alignment with the loading tray. The winch cable is attached to the loading tray. The winch is used to lift the front of the loading tray, automatically aligning it, up and over the one or more rollers. The loading tray's side guards or guides can help align the loading tray with the support member of the truck. As the winch cable is drawn in further, the loading tray can roll up on the rollers, pulling the truck or trailer back toward it, to a point of balance, where continuing winching can pull the loading tray down toward a level plane, and forward toward a ‘transport’ position. Contact with the main wheels may occur during this operation, which may assist the loading tray, to roll forward. The truck may also roll forward a small amount during this operation. The angle of the loading tray is controlled during this operation by the positions of the rollers, the wheels, and the pull of the controller. Further winching/pulling of the controller cable can pull the loading tray fully onto the truck chassis. Adding air pressure to the suspension can lift the tray, body, loading tray, or load clear of the wheels, allowing normal truck operation.

In those embodiments where the height adjustment device comprises a wedge device, it should be understood that this wedge device is inserted between the base of the transport load and the at least one wheel to transfer forces from the at least one wheel to the transport load. Unloading of the transport load from the support member can then be accomplished following a similar procedure as outlined above. In some embodiments, the wedge device can be withdrawn from between the transport load and at least one wheel once the transport load has traversed rearward sufficiently for the transport load to tip over the rotational axis of the at least one wheel towards the ground. As can be appreciated, a transport load can be loaded (or retrieved) from an external surface such as for example the ground by using the control device to pull the transport load onto the support member as outlined above.

### BRIEF DESCRIPTION OF THE DRAWINGS

The present invention can now be described with reference to the figures of the accompanying drawings, which illustrate particular preferred embodiments of the present invention, wherein:

FIG. 1 is a schematic side elevation of a trailer including one preferred embodiment of a loading and unloading arrangement according to the present invention;

FIGS. 2 to 6 show the trailer shown in FIG. 1 at successive stages of unloading and loading the container from the trailer;

FIG. 7 is a perspective view of the underside of one embodiment of a container that can be loaded on the trailer shown in FIGS. 1 to 6.

FIG. 8 is a partial front elevation providing a cross sectional view of the underside structural and guide members of the container shown in FIG. 7.

FIG. 9 shows one example of a wedge device that can be inserted between the wheels of the trailer and container shown in FIG. 1 to transfer force from the wheels of the trailer to the container.

### DETAILED DESCRIPTION

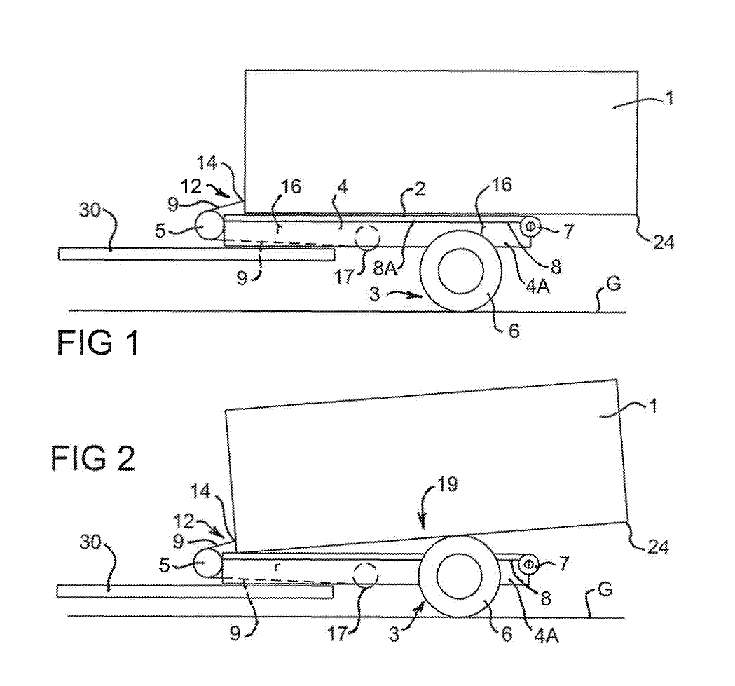

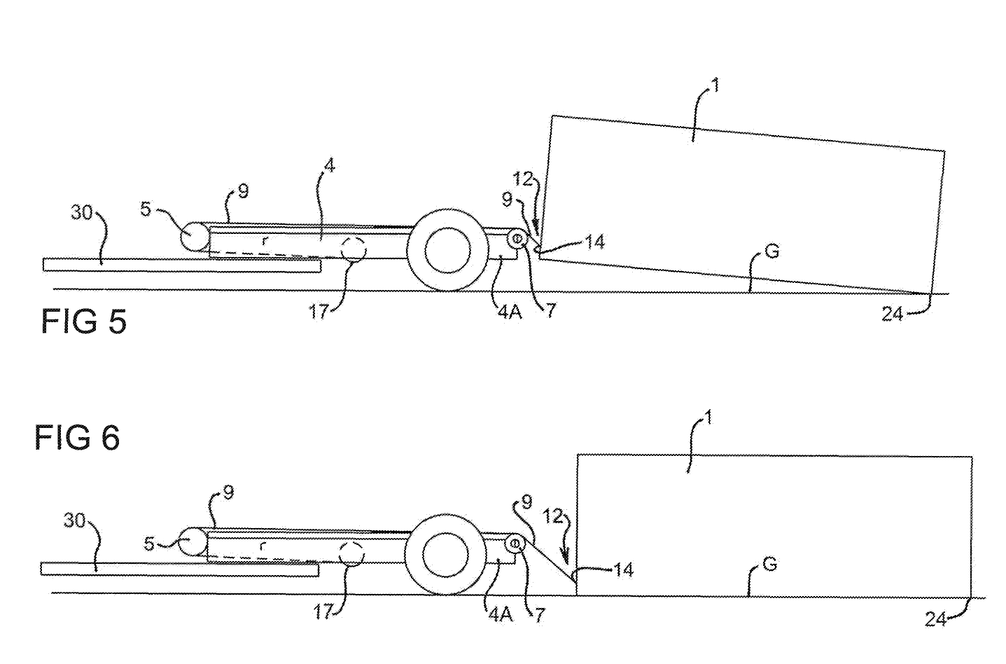

FIGS. 1 to 6 provide a sequential series of figures illustrating the steps in unloading and loading a vehicle, in this case a trailer 4, that includes one preferred embodiment of a loading and unloading arrangement according to the present invention. As can be appreciated, unloading a transport load, in this case in the form of a container 1, from the trailer 4 is illustrated by following the sequence of figures starting from FIG. 1 through to FIG. 6. Conversely, loading the container 1 onto the trailer 4 is illustrated by following the figures in reverse order starting from FIG. 6 through to FIG. 1.

While the transport load is shown in the form of a container 1 in the present figures, the transport load could be any suitable object such as a tray, container, box, platform or the like. Similarly, it should be understood that while the vehicle 4 is shown in the form of a trailer 4 in the present figures, the vehicle could be any suitable wheeled body such as for example a van, ute, truck, trailer, or other wheeled vehicle, with any type of chassis, frame, pressing, or other truck or trailer.

FIG. 1 shows the trailer 4 with the container 1 in a normal transportation position in which the base of the container 1 seated on a support member provided on the upper surface 8A of the chassis 4A of the trailer 4. A 12 mm thick Teflon rubbing strip 8 is provided on the upper surface 8A over the full length of the chassis 4A. The rubbing strip 8 provides a reduced friction supporting surface along which the container 1 can move. Two ground engaging wheels 3 (only one of which is shown in FIGS. 1 to 7) are attached to the outer longitudinal sides of the chassis 4A allowing the trailer 4 to be transported or towed through hitching framework 30.

The trailer 4 also includes one or more rollers 7 located on the rearward edge of the chassis 4A. The illustrated roller 7 is a chassis width, rubber covered roller, 7, which is securely mounted on the rearward edge of the chassis 4A. The roller 7 is positioned with the top of the roller 7 level with or slightly lower than top of the Teflon rubbing strip 8.

A control device, in the form of a winch 17, is attached to the chassis 4A. The illustrated winch 17 is a remotely controlled electric winch having a winch cable 9 connected between the winch 17 and a fastening or attachment point 14 (best shown in FIG. 8) of the container 1. The attachment point 14 is located near the leading edge 12 of the front side of the container 1. As best shown in FIG. 1, the winch cable 9 is connected to the attachment point 14 of the container 1 via a spring loaded jockey pulley 5 located at the front of the chassis 4A of the trailer 4.

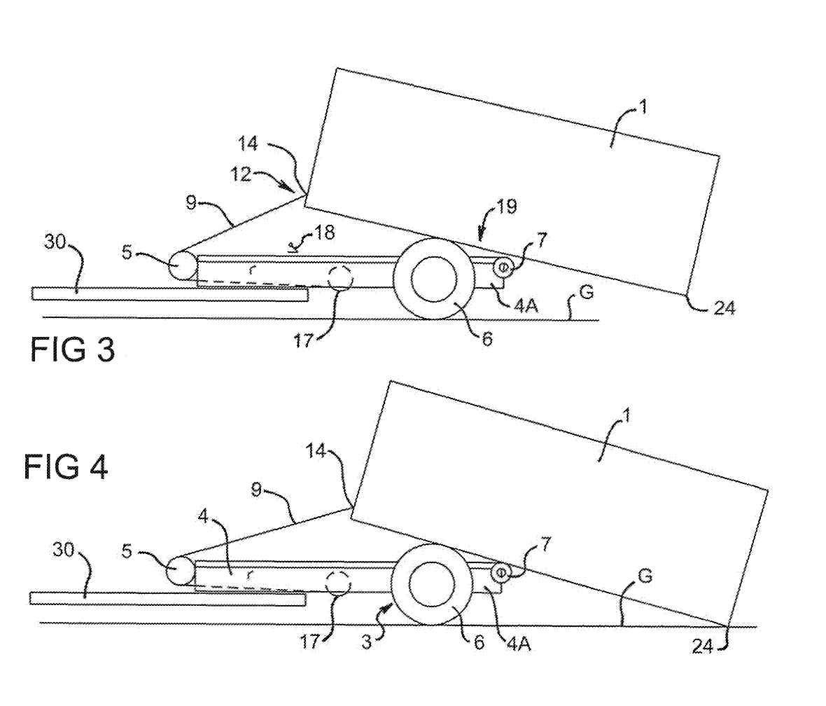

The spring loaded jockey pulley 5, controls excess spool out of the winch 17, and helps match the winch speed to the speed of wheels 3 via an electrical sensor/switch (not illustrated). An additional contact or depression switch 18 (FIG. 3), can be activated by the container 1 lifting off the upper surface 8A of the chassis 4A in order to slow the winch speed to better control the movement of the container 1 as it passes the point of balance 19 (shown in FIG. 3) and tilts downwardly towards the ground G.

A groove (not illustrated) is also provided in the center of the roller 7 to guide and carry the winch cable 9 when lowering or retrieving the container 1 from ground level G. Accordingly, when the container 1 is located at ground level G (as shown in FIG. 6), the winch cable 9, runs forward from the chassis mounted winch 17, around the jockey pulley 5, and back to the container 1, over a special cable recess in the chassis roller 7, and down to the attachment point 14 of the container 1.

The wheels 3 of the trailer 4 are attached to the chassis 4A through a height adjustment device (not illustrated) which allows the chassis 4A to be raised and lowered with respect to the wheels 3. As can be appreciated, a simple screw jack, hydraulic piston arrangement or similar could be used to achieve this function. However, in the illustrated embodiment, the trailer 4 includes a pneumatic air suspension system (not illustrated) which can be pressurised to raise and lower the chassis 4A of the trailer 4 relative to the axis of wheels 3.

FIG. 1 shows the chassis 4A in a first position (or raised position) relative to the wheels 3 in which the container 1 is above the top surface 6 of the wheels 3. In order to unload the container 1 from the trailer 4, air pressure in the suspension system of the trailer 4 is reduced to lower the container 1 into a second position (or lowered position) where a section of the base of the container 1 is in engagement with an upper contact surface 6 of each of the wheels 3 as shown in FIG. 2. In this configuration, the wheels 3 support a portion of the load provided by the container 1. The wheels 3 can now be used to move the container 1 longitudinally relative to the upper surface 8A of the trailer 4. This can be achieved by reversing the trailer 4 causing the wheels 3 to roll in a backwards direction (clockwise in the orientation shown in FIG. 2). This moves the container 1 rearwardly to a point where the centre of gravity 19 of container 1 passes over and the axis of wheels 3 and the container 1 tilts onto the rollers 7 as shown in FIG. 3. The winch cable 9 can control the tilting.

With the container 1 resting on the rear chassis roller 7, further rearward rotation of the wheel 3 can cause centre of gravity 19 of the container 1 to pass the chassis rollers 7, enabling the container 1 to tilt further toward ground level G. At this point, the contact switch 18 (FIG. 3) is used to sense the container 1 lift or tilt. Accordingly, the winch 17 speed is slowed at this point of tilting to slow the container 1 tilting speed.

The winch 17 controls the motion of the container 1 over the upper surface 8A of the chassis 4A via the winch cable 9. In this respect, tension is maintained in the winch cable 9 whilst the cable 9 is slowly unwound in order to control the speed of movement of the container 1.

As the trailer 4 is further reversed, the resulting rearward rotation of the wheels 3 moves the container 1 to a position where it is mainly supported by the rollers 7. Movement of the container 1 then is solely controlled by the winch 17. Further trailer 4 rearward movement is not required at this point as gravity can be used to lower the mass of the container 1 to ground level G. Further winch cable 9 deployment lowers the container 1 rear into contact with the ground G. Thereafter, further deployment of the winch cable 9, along with gravitational forces, can encourage the trailer 4 to roll forward, eliminating any container 1 slippage at ground level G. Slowly driving the trailer 4 forward can also minimise slippage of the container 1 from the trailer 4. When the trailing, lower edge 12 of the container 1 is in line with the axis of the wheels 3, the forward movement of the trailer 4 can be stopped, and the parking brakes of the vehicle can be engaged.

As the container 1 tilts and the rear, leading edge 24 of the container 1 contacts the ground G, as shown in FIG. 4, a base section of the container 1 is also supported by the rollers 7. The trailer 4 can then be moved forward to roll the remaining section resting on the rollers 7 off the trailer 4. Again, this motion is partially restrained by the winch 17. As shown in FIG. 5, further deployment of the winch cable 9 along with forward trailer 4 movement can cause the trailing, lower end 12 of the container 1 to roll over and be lowered down toward ground level G. The winch cable 9 now supports the weight of end 12 of the container 1. If the container 1 is evenly loaded, the cable 9 would support half of the total weight of the container 1. As can be appreciated, the cable 9 should therefore be constructed of a material strong enough to support this expected weight. Further lowering can sit the container 1 on to the ground G (FIG. 6). The winch cable 9 can be then disconnected and the container 1 left in that location.

Retrieval and loading of the container 1 onto the trailer 4 is accomplished by reversing the above described operation. In such reversal, FIG. 5 shows the container 1 being winched upward toward the rollers 7. FIG. 4 shows the container 1 being winched along the rollers 7 onto the upper surface 8A of the chassis 4A of the trailer 4; FIG. 3 shows the container 1 tilting onto the wheels 3 of the trailer 4; FIG. 2 shows the container 1 fully winched onto the support member of the trailer 4; FIG. 1 shows the container 1 in the raised position with the base of the container 1 clear of the wheels 3. The trailer 4 is now configured in the transportation position allowing the trailer 4 to be moved with the container 1 loaded thereon.

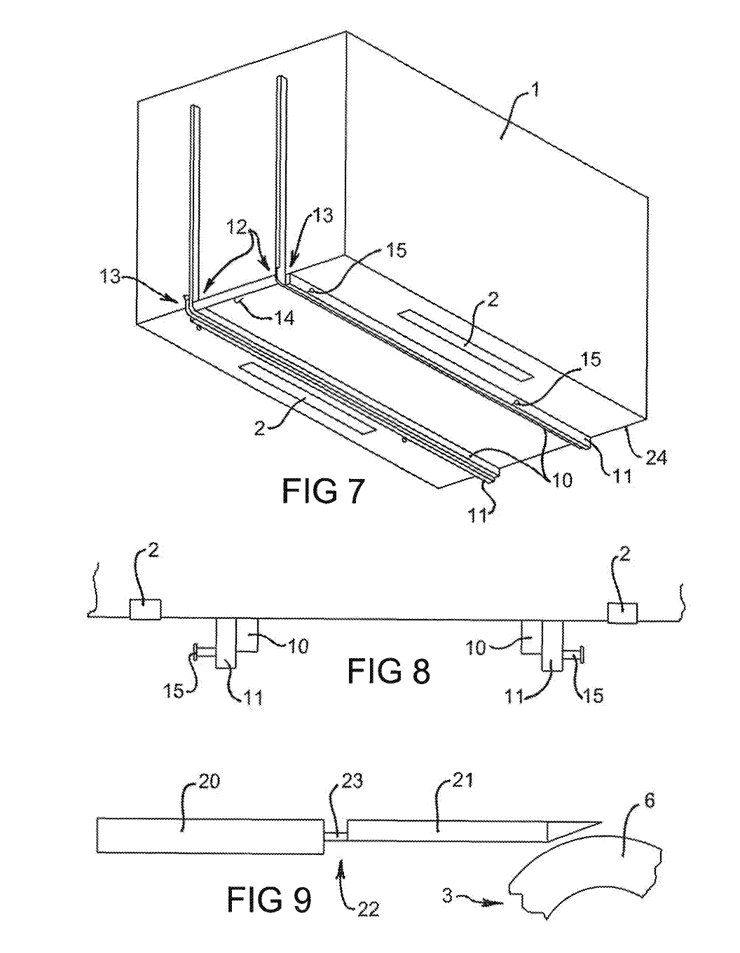

Referring now to FIGS. 7 and 8, there is shown the underside of one form of container 1 that can be loaded and loaded onto a trailer 4 shown in FIGS. 1 to 6.

The illustrated container 1 is a regular rectangular boxed container used to hold items, equipment or the like within for transportation. As shown in FIGS. 7 and 8, the container 1 may include a number of additional features that facilitate loading and unloading of the container 1 using a loading and unloading arrangement according to the present invention. These features can be built into the container 1 frame as it is being fabricated, or they can be retrofitted to an existing container 1.

The container 1 includes a fastening or attachment point 14 comprising a hook at a surface of a radiused edge 12 of the container 1. The attachment point 14 provides a connection point for the winch cable 9.

The illustrated container 1 also includes two longitudinal rails 10 spaced apart on the base and front side of the container 1. The rails 10 are configured to cooperate with two corresponding beams (not shown) of the chassis 4A of the trailer 4. In a typical configuration, each of the rails 10 rest against and align with the chassis 4A of the trailer 4. The rails 10 are preferably 75×50 or 100×50 mm rectangular hollow section steel (RHS). However, any suitable member such as an I-beam or similar could be used for the rails 10. Additional elongate RHS guide members 11 (25 to 35 mm deeper than the rails 10) are also attached, in this case welded to the outside of the rails 10 of the base section of these rails 10. These guide members 11 project downward from the rails 10 and are located on the outer sides of both rails 10. The guide members 11 provide guides to help locate the container 1 laterally on the chassis 4A of the trailer 4. The rails 10 continue above the radiused section 12, as guide plates 13 to help the container 1 centralise and roll over the rear rollers 7 when loading and unloading the container 1 from the trailer 4.

A series of spigots or steel protrusions 15 are provided on each side of the guide members 11 which can be fastened with cooperating fastening receptacles 16 (indicative location shown in FIG. 1) provided on the chassis 4A of the trailer 4 to selectively securely lock the container 1 to the chassis 4A of the trailer 4 prior to transportation. The cooperating fastening receptacles 16 can be any suitable spigot or protrusion receptacles.

As best shown in FIG. 8, the base of the container also includes two longitudinal running beams or plates 2 attached to the bottom of the container 1 frame, outward of the rails 10. These running beams or plates 2 are provided as a contact point between the wheels 3 of the trailer 4 and the container 1.

It should be appreciated that the height of the chassis 4A of the trailer 4 may need to be packed higher to allow container 1 clearance during transit at normal running height, and to allow sufficient downward or lowering suspension travel to allow the wheels 3 to protrude past the theoretical contact point with the rails 10, by 25 to 35 mm. In this configuration, the Teflon rubbing strip 8 is attached to this ‘packing’ on top of the chassis 4A, and is included in the above finished height level described above.

It is preferable for the overall trailer chassis 4A length to be shortened to approximately 200 to 300 mm past the rear most wheel circumference to provide optimum operation of the loading and loading arrangement.

As can be appreciated, unloading of this type of container 1 from the trailer 4 follows the sequence of steps detailed above. Loading of this type of container 1 onto the trailer 4 shown in FIGS. 1 to 6, is in accordance with the following procedure:

Loading of the container 1 onto a trailer 4 as shown in FIGS. 1 to 6 is achieved by reversing the trailer 4 to within half a meter or so of the container, so that the trailer 4 is in reasonable alignment with the container 1. The parking brake (not illustrated) of the tow vehicle (not illustrated) should then be applied. A user can then connect the winch cable 9 to the container 1 at connection point 14 as shown in FIG. 6. The parking brake of the tow vehicle can then be released and the winch 17 operated to wind in the winch cable 9 so as to lift the container 1 up toward the chassis roller 7 as shown in FIG. 5. This lifting operation also pulls the container 1 to a centralized position on the trailer 4. During this operation, the trailer 4 can be pulled back in line with the container 1. Engagement of the guide plates 13 with the roller 7 aligns and centralises the container 1 relative to the trailer 4. Thereafter, the leading edge 12 of the container 1 meets and rolls over the roller 7. Further operation of the winch 17 draws in the winch cable 9, thereby forcing the container 1 to roll up the chassis roller 7 and the transferring weight of the container 1 to the trailer 4 (as shown in FIG. 4). Eventually, the winch 17 moves the container 1 to a point where the container 1 is caused to tilt forward toward the trailer 4 (FIG. 2). Further winching can pull the container 1 into the transport position (FIG. 1) where the spigots or steel protrusions 15 of the container 1 can be fastened or otherwise engaged within the corresponding chassis locking components 16 to lock the container 1 in place on the trailer 4.

The air suspension system (not illustrated) of the trailer 4 can be lowered during this loading operation to help lower loading angle, and cable loads. However, the air suspension system of the trailer 4 should be primed to return the chassis 4A to the raised position when the container 1 is near or reaches the transportation position shown in FIG. 1.

FIG. 9 shows one example of a wedge device 22 that can be inserted between the wheels 3 of the trailer 4 shown in FIG. 1 and base of the container 1 to transfer force from the wheels 3 to the container 1 to move the container 1 relative to the chassis 4A of the trailer 4. This type of height adjustment device is suitable for use with vehicles such as trucks and trailers having steel spring type suspension systems which accordingly cannot be lowered by adjusting the tension or pressure within the suspension system. The wedge device 22 is used in place of an air suspension system.

The illustrated wedge device 22 is a pneumatically activated ram having a rectangular mounting body 21 which can be connected to the chassis 4A of the vehicle 1 at location on or proximate the upper surface 8 of the chassis 4A. The mounting body 21 houses the pneumatic piston and actuation arm 23. Extending from the arm 23 is a wedge shaped ram head 21. The pneumatic piston moves the ram head 21 between a normal “home” position and an extended position as shown in FIG. 9.

One or more wedge devices 22 can be connected to the chassis 4A of a vehicle 1, adjacent to the base of the container 1 and in line with the longitudinal running beams 2 in a position forward of the wheel 3 when the container 1 is positioned on the trailer 4 in a configuration shown in FIG. 1. In operation, the ram head 21 is extended rearwardly to the right in the orientation shown in FIG. 9 to jam in between the wheel 3 and the base of the container 1 and to lift the container 1 slightly away from the wheel 3. The wedge device 22 therefore bridges the gap between the top of the wheel 6 and the base of the container 1. As the vehicle 4 is reversed to rotate wheels 3, the ram head 21 and the container 1 move rearwardly. The wedge device 21 freely extends with rearward movement of the container 1 to maintain engagement between the wheel 3 and container 1. As the container 1 reaches balance point 19, the container 1 pivots and rolls around the chassis roller 7, and tips rearward. After use, the ram head 21 of the wedge device 22 could be moved to the normal home position, where it could stay for all other operations.

It should be appreciated, the general position shown in FIG. 4 can be sufficient for unloading the container 1 from the trailer 4 in some applications. In this respect, an on-board winch (not illustrated) could be used to drag immobile transport loads onto the upper surface 8A of the trailer 4. Similarly, a tipping mechanism (not illustrated) could also be included in the trailer 4 or container 1 to rotate the container 1 around the roller 7 to a position suitable to tip or dump loose components from the container 1.

It should be appreciated that the present invention opens many new industrial, commercial, and transport solutions.

In one application, interchangeable transport bodies could be configured using the loading and unloading arrangement according to the present invention. For example, a typical truck tray could be swapped for a stock crate, a water tank, a Pantec or a Curtain Sider container as required. This allows a single truck to be used for many applications as required. For example, a single truck could be used to deliver tomatoes to the market on a Sunday evening, pick up and deliver a new tractor to a farmer, deliver fresh drinking water to another residence, take cattle to the market, and deliver steel to the local engineering shop, within a 24 hour period.

The present invention can also be used to load multiple transport containers onto the support member of a transport vehicle, with singular unloading at a variety of destinations. For example, a 2.5 m. transport container could be loaded on a typically standard tray truck along with a 3.7 m. unit, while meeting all transport requirements. Alternatively, two 2.5 m, one 3.7 m, and one 4.9 m transport container could be loaded onto a typical semi trailer fitted with a loading and unloading arrangement according to the present invention.

Those skilled in the art can appreciate that the invention described herein is susceptible to variations and modifications other than those specifically described. It is understood that the invention includes all such variations and modifications which fall within the spirit and scope of the present invention.

Throughout the description and claims of the specification the word “comprise” and variations of the word, such as “comprising” and “comprises”, is not intended to exclude other additives, components, integers or steps.

1-16. (canceled)

17. A loading and unloading arrangement for loading and unloading a transport load on or from a vehicle, the vehicle including at least one support member have a support member onto which a transport load can be located and a ground engaging wheel assembly, the loading and unloading arrangement including:
at least one wheel of the wheel assembly positioned proximate to the at least one support member; and
a height adjustment device for operatively engaging the transport load with the at least one wheel,
wherein the arrangement is operable, as the vehicle is moved with the transport load engaged with the wheel, to move the transport load across and/or along the support member, in the direction in which the vehicle is moved, by rotation of the wheel.

18. The loading and unloading arrangement according to claim 17, further including a control device for limiting and controlling the movement of the transport load relative to the at least one support member.

19. The loading and unloading arrangement according to claim 18, wherein, when loading the transport load from an external location to the at least one support member, the control device is operable to move the transport load onto the at least one support member.

20. The loading and unloading arrangement according to claim 18, wherein the control device is a winch which is releasably attachable to the transport load.

21. The loading and unloading arrangement according to claim 20, wherein the winch includes at least one elongate flexible connector operatively connected between the winch and the transport load.

22. The loading and unloading arrangement according to claim 17, wherein the support member includes an unloading edge over which the transport load is moved to unload the transport load off the at least one support member, the unloading edge including a pivot device to facilitate movement of the transport load over the unloading edge.

23. The loading and unloading arrangement according to claim 22, wherein the pivot device includes at least one roller.

24. The loading and unloading arrangement according to claim 22, wherein the pivot device includes a groove configured to seat an attachment cord operatively connected to a winch.

25. The loading and unloading arrangement according to claim 17, wherein the transport load has a base defining planar surface which the at least one wheel can operatively engage to move the transport load relative to the at least one support member.

26. The loading and unloading arrangement according to claim 17, wherein the wheel assembly includes at least two spaced apart wheels proximate to the at least one support member which, in use, are operatively engaged with the base of the transport load.

27. The loading and unloading arrangement according to claim 17, wherein the at least one height adjustment device is configured to move the support member between a first position in which a transport load located on the at least one support member is spaced above the at least one wheel and a second position in which the transport load is engaged with the at least one wheel.

28. The loading and unloading arrangement according to claim 27, wherein the vehicle includes a suspension system by which a body of the vehicle is mounted on the at least one wheel, and wherein the height adjustment device is operable through the suspension system to raise and lower the support member between the first and second positions.

29. The loading and unloading arrangement according to claim 17, wherein the height adjustment device includes at least one wedge device that can be inserted between a base section of the transport load and the at least one wheel to operatively connect the at least one transport load with the at least one wheel.

30. The loading and unloading arrangement according to claim 17, wherein the at least a section of the support member of the support member has a low friction surface or at least one roller, to aid in movement of the transport load over the support member.

31. The loading and unloading arrangement according to claim 17, wherein the support member includes at least one track configured to cooperate with a corresponding elongate feature located on the base of transport load to guide movement of the transport load over the support member.

32. The loading and unloading arrangement according to claim 17, wherein the vehicle is a truck or a trailer.
